(19) United States
(12) Patent Application Publication
(10) Pub. No.: US 2025/0310148 A1
(43) Pub. Date: Oct. 2, 2025

(54) TRANSMITTING/RECEIVING DEVICE FOR A SUBSCRIBER STATION OF A SERIAL BUS SYSTEM, AND METHOD FOR COMMUNICATION USING DIFFERENTIAL SIGNALS IN A SERIAL BUS SYSTEM

(71) Applicant: Robert Bosch GmbH, Stuttgart (DE)

(72) Inventors: Steffen Walker, Reutlingen (DE); Rolf Kaack, Ruetlingen (DE); Thoralf Rosahl, Eningen (DE)

(21) Appl. No.: 19/089,831

(22) Filed: Mar. 25, 2025

(30) Foreign Application Priority Data
Mar. 27, 2024 (DE) 10 2024 202 914.9

(51) Int. Cl. H04L 12/40; G06F 13/40; G06F 13/42; H04L 25/02

(52) U.S. Cl. CPC H04L 12/40; G06F 13/4068; G06F 13/4282; H04L 25/0272

(57) ABSTRACT

A transmitting/receiving device for a subscriber station of a serial bus system. The transmitting/receiving device has a transmitting/receiving block for transmitting a digital transmit signal as an analog differential signal to a bus of the bus system to transmit a message to at least one other subscriber station of the bus system and/or for receiving an analog signal from the bus, a transformation block for outputting a voltage as a voltage supply for the transmitting/receiving block, and a terminal for an external voltage source. The transformation block is connected between the terminal for the external voltage source and the transmitting/receiving block. The transformation block is designed to transform a supply voltage applied to the terminal into a voltage which has a higher voltage value than the supply voltage applied to the terminal. A method is also described.

### CROSS REFERENCE

The present application claims the benefit under 35 U.S.C. § 119 of German Patent Application No. DE 10 2024 202 914.9 filed on Mar. 27, 2024, which is expressly incorporated herein by reference in its entirety.

### FIELD

The present invention relates to a transmitting/receiving device for a subscriber station of a serial bus system, and to method for communication using differential signals in a serial bus system.

### BACKGROUND INFORMATION

CAN bus systems are, for example, used for communication with differential signals in serial bus systems. Currently, Classical CAN and/or CAN FD, which are both standardized in the international standard ISO 11898-1:2015, are used for communication between devices in vehicles and/or in other technical devices. The devices form subscriber stations, which are also called nodes, on the bus. Each subscriber station has at least one transmitting/receiving device, also called a transceiver.

CAN FD is currently often used with a 2 Mbit/s data bit rate and a 500 kbit/s arbitration bit rate. So-called CAN SIC transmitting/receiving devices make the use of CAN FD with up to 8 Mbit/s possible. CAN XL is now available for higher data rates of currently up to 20 Mbit/s.

Currently, CAN bus systems use a voltage source of Vcc=5 V for the transmitting/receiving devices (transceivers) to generate the different voltage levels for differential signals on the bus. The signals serially signal the data to be exchanged.

For reducing costs, it is contemplated to use a voltage source of Vcc=3.3 V for the transmitting/receiving devices. Such a reduction in the supply voltage would be advantageous since the voltage of 3.3 V is used in many of today's microcontrollers. In addition, many other modules can also be supplied with this voltage.

One problem, however, is that there are already a large number of devices that can be used on the CAN bus and require a voltage supply of 5 V. Therefore, lowering the supply voltage from 5 V to 3.3 V only offers the desired advantage if devices that can be used on the CAN bus having a voltage supply of 5 V do not all have to be replaced. In particular, mixed operation on the bus must be possible. In this case, any number of 5V subscriber stations (5V nodes) and any number of 3.3V subscriber stations (3.3V nodes) must be able to communicate simultaneously on a bus.

It must be taken into account that today's CAN bus has an average voltage of Vcc/2, i.e., 2.5 V, due to the differential signals CAN_H, CAN_L. This is achieved by each bus subscriber station attempting by means of a current source via a standardized resistor network to keep the bus more or less exactly at 2.5 V. The bus voltage substantially follows the node voltage (voltage at the subscriber station) that is the lowest, and is therefore typically slightly below 2.5 V.

When transmitting, a CAN subscriber station (node), more precisely its transmitting/receiving device, can switch between a dominant state and a recessive state. For the dominant state, it drives the CAN_H level to approximately 3.5 V (Vcc-diode voltage-losses) and the CAN_L level to approximately 1.5 V (diode voltage above GND). The difference between the CAN_H level and the CAN_L level is then in a range of 2 V. The international standard ISO11898-1:2015 requires a minimum of 1.5 V. The transition from the recessive to the dominant state or back takes place as symmetrically as possible around the virtual zero line, which is Vcc/2. This keeps the sum of the levels of CAN_H and CAN_L as close to 5 V as possible.

A major problem is that even small deviations in the mV range result in significant electromagnetic emissions, which cause EMC interference (EMC=electromagnetic compatibility) in other electrical devices. Therefore, there are specifications for maximum permissible electromagnetic emissions which must be met by each transmitting/receiving device (transceiver). However, these requirements for electromagnetic emissions represent a huge challenge.

The challenges are even greater in mixed operation if at least one subscriber station on the bus has a transmitting/receiving device (transceiver) that, in the dominant state, drives different voltage levels for CAN_H and CAN_L than the transmitting/receiving devices (transceivers) of other subscriber stations. The reasons for this are as follows.

A 3.3V CAN bus works the same as the 5V CAN bus, except that the voltages on the bus are different. A 3.3V node (subscriber station) can bring the CAN_H signal to approximately 3 V and the CAN_L signal to well below 1 V for the dominant state on the bus by eliminating the diode voltage of a diode of the transmitting/receiving device (transceiver) through circuit technology. As a result, the specified minimum level difference of 1.5 V can be exceeded even in a 3.3V CAN bus system.

A special feature of mixed operation is that a 5V node in the recessive phase sets the bus to 2.5 V, while a 3V node aims at approximately 1.65 V on the bus. By increasing the CAN_L voltage in a 3.3V CAN toward 1 V, the voltage in the recessive state can be increased to approximately 1.9 V. However, a difference of approximately 500-600 mV remains between the 5V and 3.3V nodes. In such a configuration, the bus takes on a voltage somewhere between 1.9 V and 2.5 V, and a current constantly flows toward the 3.3V node, but this current is in the range of a few microamperes.

If a subscriber station (node) starts to transmit and switches to the dominant state, the subscriber station (node) does not do so from “its” zero line but from that of the mixed operation. As a result, the sum of the levels of CAN_H and CAN_L changes when switching, and again when switching back.

This inevitably leads to high EMC emissions. Mixed operation is thus not so easily possible.

### SUMMARY

It is an object of the present invention to provide a transmitting/receiving device for a subscriber station of a serial bus system and a method for communication using differential signals in a serial bus system which solve the aforementioned problems. In particular, a transmitting/receiving device for a subscriber station of a serial bus system and a method for communication using differential signals in a serial bus system are to be provided which allow communication which is reliable and as error-free and low-emission as possible in as uncomplicated and therefore economical a manner as possible on a bus to which transmitting/receiving devices can be connected which generate different voltage levels on the bus than the transmitting/receiving devices provided by the present invention.

The object may be achieved by a transmitting/receiving device for a subscriber station of a serial bus system having certain features of the present invention. According to an example embodiment of the present invention, the transmitting/receiving device has a transmitting/receiving block for transmitting a digital transmit signal as an analog differential signal to a bus of the bus system in order to transmit a message to at least one other subscriber station of the bus system and/or for receiving an analog signal from the bus, a transformation block for outputting a voltage as a voltage supply for the transmitting/receiving block, and a terminal for an external voltage source, wherein the transformation block is connected between the terminal for the external voltage source and the transmitting/receiving block, and wherein the transformation block is designed to transform a supply voltage applied to the terminal into a voltage which has a higher voltage value than the supply voltage applied to the terminal.

The transmitting/receiving device can use the transformation block to transform a voltage provided by an external voltage source for the voltage supply into a voltage having a different voltage value. Therefore, a transmitting/receiving block with which the transmitting/receiving device is connected to the bus can be designed for a voltage supply having a different voltage value than that provided by the external voltage supply.

For example, the transmitting/receiving device of the present invention can be supplied with a voltage of approximately 3.3 V, at least 3.0 V, with which a zero line of approximately 1.9 V on the bus can be generated for differential signals. Nevertheless, the transmitting/receiving device of the present invention can use a transmitting/receiving block which can generate a zero line of approximately 2.5 V for the differential signals on the bus based on a voltage supply of approximately 5.0 V.

The transmitting/receiving device of the present invention thus solves the problem where even conventional transmitting/receiving blocks can continue to be operated in a system which only provides an external voltage supply having a voltage of approximately 3.3 V, at least 3.0 V.

The transmitting/receiving device of the present invention ensures that the zero line on the bus is brought to the level which is required or may be used in the bus system before transmitting a dominant state. Of course, this applies not only to the zero line before transmitting a dominant state but also between such states. The emissions that cause electromagnetic compatibility (EMC) problems can thereby be significantly reduced and, in the best case, minimized in the phase in which the subscriber station, more precisely its transmitting/receiving device, is transmitting.

In this way, the transmitting/receiving device of the present invention allows mixed operation of transmitting/receiving devices which can be operated with different voltages, in particular of 3.3 V transmitting/receiving devices and 5 V transmitting/receiving blocks or 5 V transmitting/receiving devices, in a system having a voltage supply having a voltage of approximately 3.3 V, at least 3.0 V.

As a result, the transmitting/receiving device of the present invention can provide resource conservation and cost savings for the bus system while still allowing low-emission and error-free operation of the bus system.

Overall, the transmitting/receiving device of the present invention not only can realize communication even at a voltage supply of approximately 3.3 V in the bus system between other 5 V transmitting/receiving devices with the (high) bit rates required for the relevant communication standard, but also helps to ensure that the transmittable bit rate is not reduced by errors in the communication.

Advantageous further embodiments of the transmitting/receiving device are disclosed herein.

The supply voltage applied to the terminal can be a direct voltage.

The supply voltage applied to the terminal can be a voltage having a voltage value of approximately 3.3 V, at least 3.0 V, wherein the voltage output by the transformation block can be a voltage having a voltage value of approximately 5.0 V.

According to one exemplary embodiment of the present invention, the transformation block has a first and a second transistor, the drain terminals of which are connected to one another, and a first and a second diode which are connected in series between an input of the transformation block and its output, wherein the source terminal of the first transistor is connected to the anode of the first diode, wherein a first capacitor is connected to the cathode of the first diode and is connected at its other terminal to the drain terminals of the first and second transistors, and wherein a capacitor is connected to the cathode of the second diode and is connected at its other terminal to the source terminal of the second transistor and to a terminal for ground.

The transmitting/receiving device can also have a clock block for controlling the transformation block with a clock signal for transforming the supply voltage applied to the terminal into the voltage which has a higher voltage value than the supply voltage applied to the terminal.

It is possible that the gate terminals of the first and second transistors are connected.

The clock block can be connected to the gate terminals of the first and second transistors to drive the first and second transistors with the clock signal.

According to another exemplary embodiment of the present invention, the transformation block further comprises a third and a fourth transistor, wherein the third transistor shunts out the first diode, and wherein the fourth transistor shunts out the second diode.

In one example embodiment of the present invention, the transmitting/receiving block, the transformation block, the clock block and the terminal for an external voltage source are arranged monolithically on a semiconductor chip.

According to yet another exemplary embodiment of the present invention, the transmitting/receiving device further comprises a first control block for controlling the ripple of the voltage output by the transformation block to a minimum value.

According to yet another exemplary embodiment of the present invention, the transmitting/receiving device further comprises a second control block for controlling the voltage output by the transformation block to a predetermined voltage value.

According to an example embodiment of the present invention, the second control block may comprise a transistor, a capacitor and an operational amplifier, wherein the transistor is connected between the output of the transformation block and the transmitting/receiving block, wherein the output of the operational amplifier is connected to the gate terminal of the transistor, and wherein the capacitor is connected at one of its terminals to the drain terminal of the transistor and at its other terminal to a terminal for ground.

According to an example embodiment of the present invention, the receiving/transmitting device can be designed to generate the analog differential signal with a different physical layer in a first communication phase of the message than in a second communication phase.

The transmitting/receiving device of the present invention described above can be part of a subscriber station for a serial bus system, which additionally comprises a communication control device for controlling the communication in the serial bus system and for generating the transmit signal, wherein the subscriber station is designed for communication in a bus system in which an exclusive, collision-free access of a subscriber station to the bus of the bus system is ensured at least temporarily.

The bus system can have a bus and at least two subscriber stations which are connected to one another via the bus in such a way that they can communicate serially with one another and of which at least one subscriber station is a subscriber station according the present invention described above.

The aforementioned object may also be achieved by a method for communication using differential signals in a serial bus system having certain features of the present invention. The method is carried out using a transmitting/receiving device for a subscriber station of the serial bus system which has a transmitting/receiving block, a transformation block, and a terminal for an external voltage source, wherein the transformation block is connected between the terminal for the external voltage source and the transmitting/receiving block, and wherein the method comprises the steps of outputting, with the transformation block, a voltage as a voltage supply for the transmitting/receiving block, and transmitting a digital transmit signal as an analog differential signal to a bus of the bus system using the voltage output by the transformation block in order to transmit a message to at least one other subscriber station of the bus system, and/or receiving an analog signal from the bus using the voltage output by the transformation block, wherein the transformation block is designed to transform a supply voltage applied to the terminal into a voltage which has a higher voltage value than the supply voltage applied to the terminal.

The method of the present invention offers the same advantages as those mentioned above with respect to the transmitting/receiving device of the present invention.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention, in view of the disclosure herein.

### BRIEF DESCRIPTION OF THE DRAWINGS

The present invention is described in more detail below with reference to the figures and on the basis of (an) exemplary embodiment(s).

FIG. 1 shows a simplified block diagram of a bus system according to a first exemplary embodiment of the present invention.

FIG. 2 shows a diagram for illustrating the structure of a message which can be transmitted by a first subscriber station of the bus system according to the first exemplary embodiment of the present invention.

FIG. 3 shows a time profile of a digital transmit signal during operation of the bus system at the first and/or second subscriber station, which is connected with at least a first subscriber station to the same bus of the bus system, according to an example embodiment of the present invention.

FIG. 4 shows a time profile of bus signals CAN_H and CAN_L at the second subscriber station according to the first exemplary embodiment of the present invention.

FIG. 5 shows a time profile of a differential voltage VDIFF of the bus signals CAN_H and CAN_L at the first and the second subscriber station according to the first exemplary embodiment of the present invention.

FIG. 6 shows a time profile of a digital receive signal which the first or second subscriber station generates from a signal received from the bus and which is based on the transmit signal of FIG. 3.

FIG. 7 shows a time profile of bus signals CAN_H and CAN_L, which can be generated on the bus by the first subscriber station according to the first exemplary embodiment, starting from the transmit signal of FIG. 3.

FIG. 8 shows an example of a time profile of a digital transmit signal which is to be converted in an arbitration phase (SIC operating mode of a transmitting module) into bus signals CAN_H, CAN_L for a bus of the bus system of FIG. 1.

FIG. 9 shows the time profile of the bus signals CAN_H, CAN_L during switching from a recessive bus state to a dominant bus state and back to the recessive bus state, which bus signals are transmitted onto the bus in the arbitration phase (SIC operating mode) due to the transmit signal of FIG. 8.

FIG. 10 shows a circuit diagram of a transmitting/receiving device for a subscriber station of the bus system according to the first exemplary embodiment of the present invention.

FIG. 11 shows a circuit diagram of a transmitting/receiving device for a subscriber station of the bus system according to a second exemplary embodiment of the present invention.

FIG. 12 shows a circuit diagram of transmitting/receiving device for a subscriber station of the bus system according to a third exemplary embodiment of the present invention.

FIG. 13 shows a circuit diagram of a transformation block for a transmitting/receiving device for a subscriber station of the bus system according to a fourth exemplary embodiment of the present invention.

In the figures, identical or functionally identical elements are given the same reference signs unless otherwise indicated.

### DETAILED DESCRIPTION OF EXAMPLE EMBODIMENTS

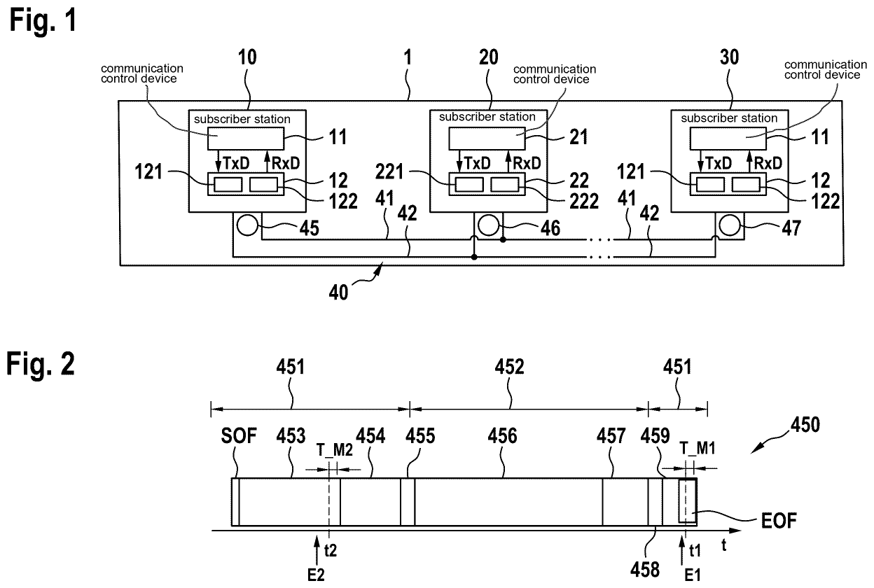

FIG. 1 shows a bus system 1, which can, for example, at least in sections, be a CAN bus system, a CAN FD bus system, etc. The bus system 1 can be used in a vehicle, in particular a motor vehicle, an aircraft, etc., or in a hospital, etc.

Even though the bus system 1 is described below using CAN bus systems, the bus system 1 is not limited to CAN bus systems.

In FIG. 1, the bus system 1 has a plurality of subscriber stations 10, 20, 30, which are each connected to a bus 40 or bus line having a first bus wire 41 and a second bus wire 42. In a CAN bus system, the bus wires 41, 42 can also be called CANH and CANL for carrying signals CAN_H, CAN_L on the bus 40.

Messages 45, 46, 47 in the form of signals are transferred between the individual subscriber stations 10, 20, 30 via the bus 40. The subscriber stations 10, 20, 30 are, for example, control devices or display devices of a motor vehicle.

As shown in FIG. 1, the subscriber stations 10, 30 each have a communication control device 11 and a transmitting/receiving device 12. The transmitting/receiving device 12 has a transmitting module 121 and a receiving module 122. At least one of the subscriber stations 10, 20, 30 uses a supply voltage of 3.3 V, at least 3.0 V. It is also possible for at least one subscriber station 10, 20, 30 to use a supply voltage of 5 V. For illustration purposes, the following explanations show an example of a network or bus system 1 in which all subscriber stations 10, 20, 30 are supplied with an electrical voltage having a supply voltage of approximately 3 V, at least 3.0 V. For example, the subscriber stations 10, 30 are designed to transmit signals having a bus midpoint voltage of 1.9 V or 2.5 V to the bus. In addition, the subscriber station 20 is designed to transmit signals having a bus midpoint voltage of 2.5 V to the bus. Alternatively, any other constellations are possible.

The subscriber station 20 has a communication control device 21 and a transmitting/receiving device 22. The transmitting/receiving device 22 has a transmitting module 221 and a receiving module 222.

The transmitting/receiving devices 12 of the subscriber stations 10, 30 and the transmitting/receiving device 22 of the subscriber station 20 are each directly connected to the bus 40, even though this is not shown in FIG. 1.

The communication control devices 11, 21 are each used for controlling communication of the corresponding subscriber station 10, 20, 30 via the bus 40 with at least one other subscriber station of the subscriber stations 10, 20, 30 which are connected to the bus 40.

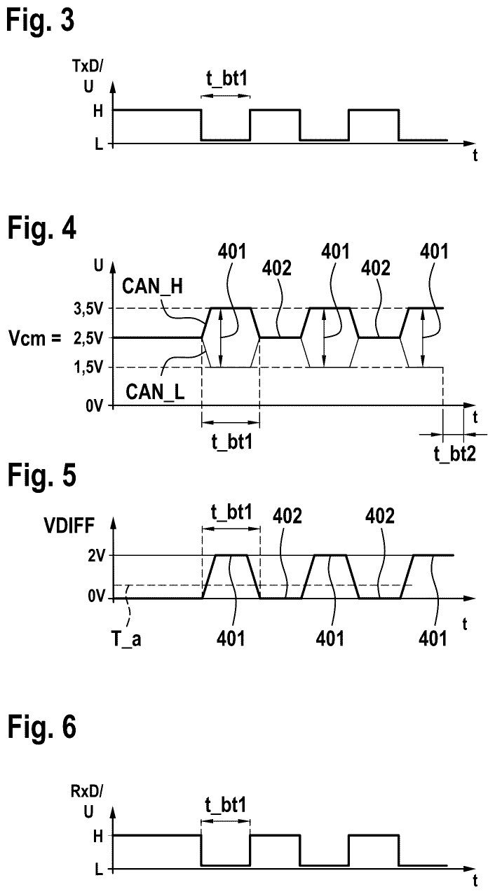

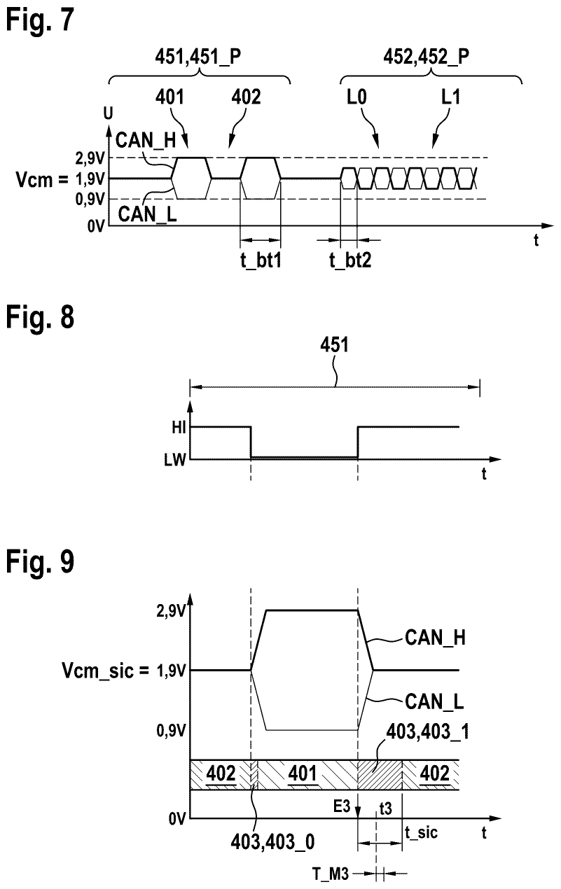

The communication control device 11 creates and reads first messages 45, 47, which are, for example, modified CAN messages 45, 47. Here, the modified CAN messages 45, 47 are in particular structured on the basis of the CAN XL format. The transmitting/receiving device 12 serves for transmitting and receiving the messages 45, 47 from the bus 40. The transmitting module 121 receives a digital transmit signal TxD created by the communication control device 11 for one of the messages 45, 47 and converts it into signals on the bus 40, as described in more detail with reference to FIG. 3, FIG. 4, and FIG. 7. The digital transmit signal TxD can be a pulse-width-modulated signal, at least temporarily or in sections. The receiving module 122 receives signals transmitted on the bus 40 corresponding to the messages 45 to 47 and generates a digital receive signal RxD therefrom, for which an example is shown in FIG. 6. The receiving module 122 transmits the receive signal RxD to the communication control device 11.

In addition, the communication control device 11 may optionally be designed to create and read second messages 46, which are, for example, CAN FD messages or CAN SIC messages 46. The transmitting/receiving device 12 can be designed accordingly.

The communication control device 21 can be designed as a conventional CAN controller according to ISO 11898-1:2015, i.e. as a CAN FD-tolerant Classical CAN controller or as a CAN FD controller. The communication control device 21 creates and reads second messages 46, for example CAN FD messages or CAN SIC messages. The transmitting/receiving device 22 is used to transmit and receive the messages 46 to/from the bus 40. The transmitting module 221 receives a digital transmit signal TxD created by the communication control device 21 and converts it into signals for a message 46 on the bus 40, as described in more detail with reference to FIG. 3 and FIG. 4. The receiving module 222 receives signals transmitted on the bus 40 corresponding to the messages 45 to 47 and generates a digital receive signal RxD therefrom, for which an example is shown in FIG. 6. The transmitting/receiving device 22 may be designed like a conventional CAN FD transceiver or CAN SIC transceiver. For transmitting the messages 45, 46, 47 with CAN SIC or CAN XL, proven properties that are responsible for the robustness and user friendliness of CAN and CAN FD, in particular the frame structure with the identifier and the arbitration according to the conventional CSMA/CR method, are adopted, as described in more detail below.

With the two subscriber stations 10, 30, a formation and then a transmission of messages 45, 46, 47 with different CAN formats, in particular the CAN FD format or the CAN SIC format or the CAN XL format, as well as the reception of such messages 45, 46, 47 can be realized. This is described in more detail below for a message 45.

FIG. 2 shows, for the message 45, a frame 450, which is in particular a CAN XL frame, said frame being provided by the communication control device 11 for the transmitting/receiving device 12 for transmission onto the bus 40. In this case, the communication control device 11 creates the frame 450 as compatible with CAN FD in the present exemplary embodiment. Alternatively, the frame 450 is compatible with any successor standard for CAN FD.

According to FIG. 2, the frame 450 is divided, for CAN communication on the bus 40, into different communication phases 451, 452, namely an arbitration phase 451 (first communication phase) and a data phase 452 (second communication phase). After a start bit SOF, the frame 450 has an arbitration field 453, a control field 454, a first switching field 455, a data field 456, a checksum field 457, a second switching field 458 and a frame termination field 459, in which a marking EOF (EOF=end of frame) is present. The checksum field 457, the second switching field 458 and the frame termination field 459 form a frame end phase 457, 458, 459 of the frame 450. In the frame termination field 459, there may be an acknowledgment field (ACK), which is not shown in the figures.

In contrast to the frame 450 of FIG. 2, no switching fields 455, 458 are present in a CAN FD frame, which the subscriber station 20 uses for the second message 46.

It is true for all aforementioned CAN versions that, in the arbitration phase 451, with the aid of an identifier (ID) in the arbitration field 453, negotiation takes place bitwise between the subscriber stations 10, 20, 30 as to which subscriber station 10, 20, 30 wishes to transmit the message 45, 46, 47 with the highest priority and is therefore granted exclusive access to the bus 40 of the bus system 1 for the near future for transmitting in the subsequent data phase 452. A physical layer such as in CAN and CAN FD is used in the arbitration phase 451. The physical layer corresponds to the bit transmission layer or layer 1 of the conventional OSI model (Open Systems Interconnection Model).

During the phase 451, the conventional CSMA/CR method is used, which allows simultaneous access of the subscriber stations 10, 20, 30 to the bus 40 without the higher priority message 45, 46, 47 being destroyed. As a result, further bus subscriber stations 10, 20, 30 can be added relatively easily to the bus system 1, which is very advantageous.

The CSMA/CR method has the consequence that there must be so-called recessive states on the bus 40, which can be overwritten by other subscriber stations 10, 20, 30 with dominant levels or dominant states on the bus 40. In the recessive state, high-impedance conditions prevail at the individual subscriber station 10, 20, 30, which in combination with the parasites on the bus circuit results in longer time constants. This leads to a limitation of the maximum bit rate of the present-day CAN-FD physical layer at currently about 2 megabits per second in real vehicle use.

At the end of the arbitration phase 451, switching to the data phase 452 takes place. In the case of CAN XL, switching takes place by means of the first switching field 455 of FIG. 2.

In the case of CAN XL, in the data phase 452, in addition to a portion of the first switching field 455, the payload data of the CAN XL frame 450 or of the message 45 from the data field 456 are transmitted, and so are the checksum field 457 and a portion of the second switching field 458. In the case of CAN FD, the payload data of the CAN FD frame or of the message 46 from the data field 456 are transmitted, and so is the checksum field 457.

At the end of the data phase 452, switching back to the arbitration phase 451 takes place. In the case of CAN XL, switching takes place by means of the second switching field 458 of FIG. 2.

A transmitter of the message 45 does not begin to transmit bits of the data phase 452 onto the bus 40 until the subscriber station 10 as the transmitter has won the arbitration and the subscriber station 10 as the transmitter thus has exclusive access to the bus 40 of the bus system 1 for transmitting.

A bit sequence is provided in the frame end field EOF, which bit sequence marks the end of the frame 450. This means that the bit sequence of the end field (EOF) is used to mark the end of the frame 450. The end field (EOF) ensures that a number of 7 recessive bits is transmitted at the end of the frame 450. Together with an optional ACK delimiter in the acknowledgment field (not shown), a number of 8 recessive bits is transmitted at the end of the frame 450. The mentioned bit sequence of recessive bits are bit sequences that cannot occur within the frame 450. As a result, the end of the frame 450 can be reliably recognized by the subscriber stations 10, 30.

Starting from a point in time or a time t1, more precisely starting with the time t1, for a time period T_M1, the subscriber station 10 carries out a detection of the bus potential or the bus voltage present on the bus 40. The detection is carried out after an event E1 has occurred. The event E1 is that a predetermined number of directly consecutive recessive bits has occurred at the end of the frame 450, more precisely in the end field (EOF).

Optionally, the subscriber station may, starting from a time t2, more precisely starting with the time t2, for a time period T_M2, carry out a detection of the bus potential or the bus voltage present on the bus 40. The detection is carried out after an event E2 has occurred. The event E2 is that, at the end of the first communication phase, the subscriber station that will have exclusive access to the bus in the following second communication phase and will thus be allowed to transmit its message is ascertained.

This/these detection(s) or measurement(s) is/are described below with reference to the figures.

After the end field (EOF), which has 7 bits, an interframe space (IFS), not shown in FIG. 2, follows in the frame 450. In CAN FD, this interframe space (IFS) is designed in accordance with ISO11898-1:2015. The interframe space (IFS) has at least 3 bits.

Otherwise, the fields and bits mentioned are from ISO 11898-1:2015 and for this reason are not described in more detail here.

Thus, in the arbitration phase 451 as the first communication phase, the subscriber stations 10, 30 use, in part, in particular up to the FDF bit (inclusive), a format from CAN/CAN FD, according to ISO11898-1:2015. However, in comparison with CAN or CAN FD, an increase in the net data transfer rate, in particular to over 10 megabits per second, is possible in the data phase 452 as the second communication phase. In addition, an increase in the size of the payload data per frame, in particular to about 2 kilobytes or any other value, is possible.

FIG. 3, FIG. 5, and FIG. 6 illustrate, as an example, the signals that are generated at the subscriber stations 10, 20, 30 during operation of the bus system 1. FIG. 4 illustrates, as an example, the signals that are transmitted from the subscriber station 20 to the bus 40 during operation of the bus system 1. As mentioned above, the subscriber station 20 generates a bus midpoint voltage Vcm of approximately 2.5 V at a supply voltage of approximately 3.3 V, at least 3.0 V.

FIG. 7 shows the bus signals which each of the subscriber stations 10, 30 can generate instead of the bus signals shown in FIG. 4. As mentioned above, the subscriber stations 10, 30 can generate the signals of FIG. 7 in one alternative with a bus midpoint voltage Vom of approximately 1.9 V, as shown in FIG. 7. In addition, the subscriber stations 10, 30 can be designed to alternatively generate signals which are from CAN XL.

During operation of the bus system 1, each of the transmitting modules 121, 221 of FIG. 1 can serially convert a transmit signal TxD of the associated communication control device 11 into corresponding signals CAN_H, CAN_L for CAN or CAN FD for the bus wires 41, 42 and transmit these signals at the terminals for CAN_H and CAN_L onto the bus 40. The corresponding communication control device 11, 21 transmits the transmit signal TxD of FIG. 3 over time t (serially) to the associated transmitting module 121, 221, as shown in FIG. 1.

As shown as an example in FIG. 3, the transmit signal TxD has the voltage states H (high) and L (low) with a corresponding voltage U. The individual bits of the signal TxD have a bit time t_bt1, as shown in FIG. 3 for the arbitration phase 451. In the case of CAN FD and CAN XL, the bits of the TxD signal in the data phase 452 can be transmitted with a shorter bit time t_bt2, as illustrated in FIG. 4.

The sequence of the states H, L of the transmit signal TxD of FIG. 3 and the resulting states 401, 402 for the signals CAN_H, CAN_L in FIG. 4 along with the resulting profile of the voltage VDIFF of FIG. 5 are used only to illustrate the function of the subscriber station 10. The sequence of the data states for the bus states 401, 402 can be selected as required.

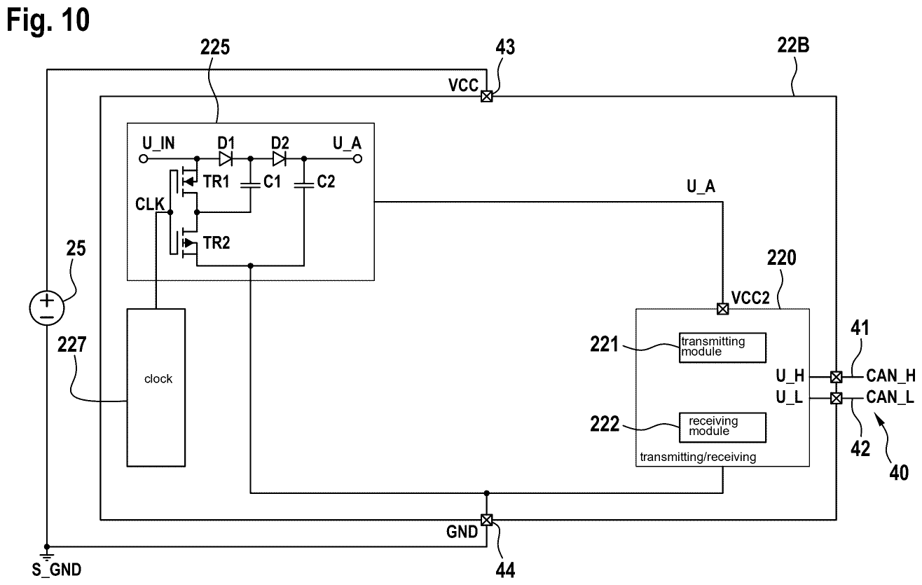

According to the example of FIG. 4, the signals CAN_H and CAN_L have, at least in the arbitration phase 451, the dominant and recessive bus levels or bus states 401, 402, as from CAN. The subscriber station 20 whose design is shown below in FIG. 10 drives the CAN_H level to approximately 3.5 V and the CAN_L level to approximately 1.5 V for the dominant state 401, as shown in FIG. 4. The recessive state 402 occurs at 2.5 V, which is equal to the bus midpoint voltage Vcm=2.5 V.

As shown in FIG. 5 for the differential voltage VDIFF=CAN_H−CAN_L on the bus 40, the difference between the CAN_H level and the CAN_L level for the dominant state 401 is then in a range of 2 V.

The receiving modules 122, 222 form a receive signal RxD from signals CAN_H and CAN_L received from the bus 40, which are shown in FIG. 4, or from the differential voltage VDIFF of FIG. 5. For the generation of the digital receive signal RxD of FIG. 6, each receiving module 122, 222 evaluates the signal VDIFF received from the bus 40 or at least one of the signals CAN_H, CAN_L with receiving thresholds, as is conventional. In FIG. 6, the receive signal RxD is shown without propagation delay. The receiving module 122 forwards this receive signal RxD to the associated communication control device 11, 21, as shown in FIG. 1.

In contrast to FIG. 4, FIG. 7 shows the signals CAN_H and CAN_L, which the subscriber stations 10, 30 can generate on the bus 40 as an alternative to the signals from CAN XL in the arbitration phase 451 and the data phase 452. At least in the arbitration phase 451, the dominant and recessive bus levels or bus states 401, 402 are used, as shown in FIG. 4. If the subscriber stations 10, 30 generate a bus midpoint voltage of 1.9 V, they drive the CAN_H level to approximately 2.9 V and the CAN_L level to approximately 0.9 V for the dominant state 401, as shown in FIG. 7. The recessive state 402 occurs at 1.9 V, which is equal to the bus midpoint voltage Vcm=1.9 V. In the data phase 452, CAN XL can use a different physical layer 452_P than the physical layer 451_P in the arbitration phase 451. Consequently, the CAN_H levels can be driven to values for the states L0, L1, as shown in FIG. 7. A physical layer such as in CAN and CAN FD is used in the arbitration phase 451. The physical layer corresponds to the bit transmission layer or layer 1 of the conventional OSI model (Open Systems Interconnection Model).

For the transmit signal TxD of FIG. 3, the transmitting module 121 generates the signals CAN_H, CAN_L in FIG. 7 for the bus wires 41, 42 in such a way that the state L0 is formed for a state LW (low). In addition, the state L1 is formed for a state HI (high).

If the subscriber stations 10, 30 are to generate a bus midpoint voltage of 2.5 V, as from CAN XL, the signals of FIG. 7 have a bus midpoint voltage Vcm of approximately 2.5 V and voltage values for the signals CAN_H, CAN_L in the arbitration phase 451, as shown in FIG. 4 and described above, and in the data phase 452 with values of 1V and −1V for the states L0, L1.

In order to increase the data rate for CAN XL, the transmitting/receiving devices 12 can be designed for CAN SIC.

As shown in more detail in FIG. 8 and FIG. 9, for the transmit signal TxD of FIG. 8, the transmitting module 121 in CAN SIC generates the signals CAN_H, CAN_L according to FIG. 9 for the bus wires 41, 42 at a bus midpoint voltage Vcm_sic=1.9 V and in such a way that a state 403 (sic) is additionally present. Alternatively, a bus midpoint voltage Vom of approximately 2.5 V as well as voltage values for the signals CAN_H, CAN_L are generated in the arbitration phase 451, as shown in FIG. 4.

The state 403 (SIC) can have different lengths, as shown with the state 403_0 (sic) during the transition from the state 402 (rec) to the state 401 (dom) and with the state 403_1 (sic) during the transition from the state 401 (dom) to the state 402 (rec). The state 403_0 (sic) is shorter in time than the state 403_1 (sic). In order to generate signals according to FIG. 9, the transmitting module 121 is switched to a SIC operating mode (SIC mode).

Passing through the short sic state 403_0 is not required in CiA610-3, and the state is dependent on the type of implementation. The duration of the “long” state 403_1 (sic) is specified for CAN SIC as well as for the SIC operating mode in CAN XL as t_sic<530 ns, starting with the rising edge of the transmit signal TxD of FIG. 5.

Starting from a point in time or a time t3, more precisely starting with the time t3, after an event E3 has occurred, for a time period T_M3, the subscriber station 10 carries out a detection of the bus potential or the bus voltage present on the bus 40. The event E3 is that the state 401 (dom) is left or switching takes place from the state 401 (dom) to the state 403 (sic). Depending on the detection result, the subscriber station 10 then adjusts itself to transmit the signals CAN_H, CAN_L with a bus midpoint voltage Vcm=1.9 V or Vcm=2.5 V to the bus 40.

In the “long” state 403_1 (sic), the transmitting module 121 should adapt the impedance between the bus wires 41 (CANH) and 42 (CANL) as well as possible to the characteristic impedance Zw of the bus line used. Here, Zw equals 100 ohms or 120 ohms. This adaptation prevents reflections and thus allows operation at higher bit rates. For the sake of simplicity, hereinafter reference will always be made to the state 403 (sic) or sic state 403.

FIG. 10 shows the transmitting/receiving device 22 of the subscriber station 20 of FIG. 1 on the bus 40 in more detail. The transmitting/receiving device 22 has a transmitting/receiving block 220 which has the transmitting module 221 and the receiving module 222. The transmitting/receiving device 22 also has a transformation block 225 and a clock block 227.

The transmitting/receiving device 22 has a terminal 43 for a voltage supply VCC and a terminal 44 for ground GND or CAN-GND. The terminal 44 is connected to a system ground S GND. In addition, the transmitting/receiving device has 22 terminals for the bus lines 41, 42 of the bus 40. The transmitting/receiving device 22 has other terminals, such as terminals TXD for a transmit signal, RXD for a receive signal, VIO, STB, even if these are not shown in FIG. 10 for simplification.

The transmitting/receiving block 220 has an input VCC2 for an output voltage U_A of the transformation block 225.

In FIG. 10, a voltage source 15 is connected between the terminals 43, 44. The voltage source 15 is arranged externally of the transmitting/receiving device 22. The voltage source 25 can be part of the subscriber station 20. The voltage source 25 supplies the transmitting/receiving device 22 with a direct voltage having a voltage value of approximately 3.3 V, but at least 3.0 V.

During transmission operation, the transmitting/receiving device 22 outputs differential voltages U_H=3.5 V and U L=1.5 V for the signals CAN_H, CAN_L at its output, as described above with reference to FIG. 4.

According to FIG. 10, the transformation block 225 has an electrical circuit having two diodes D1, D2, two transistors TR1, TR2 and two capacitors C1, C2. The capacitor C1 has the function of a pump capacitor. The capacitor C2 has the function of a temporary storage or buffer memory. The capacitor C2 can also be called a buffer storage capacitor. An electrical voltage U_IN is present at the input of the transformation block 225. An electrical voltage U_A is output at the output of the transformation block 225.

The transistors TR1, TR2 are each CMOS transistors. The transistor TR1 is in particular an NMOS transistor. The transistor TR2 is in particular a PMOS transistor. The abbreviation “CMOS” refers to a semiconductor device that uses both p-channel and n-channel MOSFETs on a common substrate. The abbreviation CMOS stands for “complementary metal-oxide-semiconductor”. The abbreviation “MOSFET” stands for “metal oxide semiconductor field-effect transistor”.

The clock generator 227 is connected to the gate terminals of the two transistors TR1, TR2. The input of the transformation block 225 is connected to the source terminal of the first transistor TR1 and the anode of the first diode D1. The drain terminal of the first transistor TR1 is connected to the drain terminal of the second transistor TR2. The source terminal of the second transistor TR2 is connected to the terminal 44 for ground GND. The cathode of the first diode D1 is connected to the anode of the second diode D2 and to a terminal of the first capacitor C1. The other terminal of the capacitor C1 is connected to the drain terminals of the first and second transistors TR1, TR2. The cathode of the second diode D1 is connected to the output of the transformation block 225 and to a terminal of the second capacitor C2. The other terminal of the second capacitor C2 is connected to the terminal 43 for ground GND and the source terminal of the second transistor TR2. The diodes D1 and D2 are connected in series between the input and output of transformation block 225.

The clock generator 227 outputs a clock signal CLK to the gate terminals of the two transistors TR1, TR2 to activate the transformation block 225. For example, the clock signal CLK is fixed.

The transmitting/receiving device 22 is a self-contained device in which a transmitting/receiving block 222, which is designed for a voltage supply of typically 5 V at its terminal VCC2, is monolithically supplemented with the transformation block 225 and the clock block 227. The transformation block 225 is connected upstream of the transmitting/receiving block 222. The transformation block 225 operates as a charge pump, in particular a single-stage charge pump. For such a charge pump, the following equations (1) to (3) apply

$$U\_A0 = ( U\_IN - U\_D ) * 2 \qquad ( 1 )$$

$$U\_A = U\_A0 - R\_i * I\_L \qquad ( 2 )$$

$$R\_i = 1 / ( f * C 1 ) \qquad ( 3 )$$

Here, U_A0 is the output voltage of the unloaded charge pump, U_IN is the input voltage of the unloaded charge pump, U_D is the voltage across the diodes D1 and D2, U_A is the output voltage of the loaded charge pump, R_i is the internal resistance of the charge pump, I_L is the electric current through the load on the charge pump, in other words the electric current drawn by the loaded charge pump, f is the frequency of the clock CLK and C1 is the capacitance value of the capacitor C1 or the pump capacitor.

Thus, only the 3.3 V voltage can be applied to terminal 43 (VCC). This voltage is then converted to a higher voltage by the transformation block 225 arranged on the same chip and fed to the transmitting/receiving block 222, which is designed for a voltage supply of 5 V, at the terminal VCC2. Advantageously, the associated elimination of the 5 V supply is realized at system level, i.e., outside the transmitting/receiving device 22 (transceiver). All other terminals of the transmitting/receiving device 22, in particular the terminals CANH, CANL, VIO, TXD, RXD, GND, STB of the block 220 with the 8 terminals, behave exactly like the other terminals of the block 220, which has the 8 terminals 5 V CAN, CANH, CANL, VIO, TXD, RXD, GND, STB.

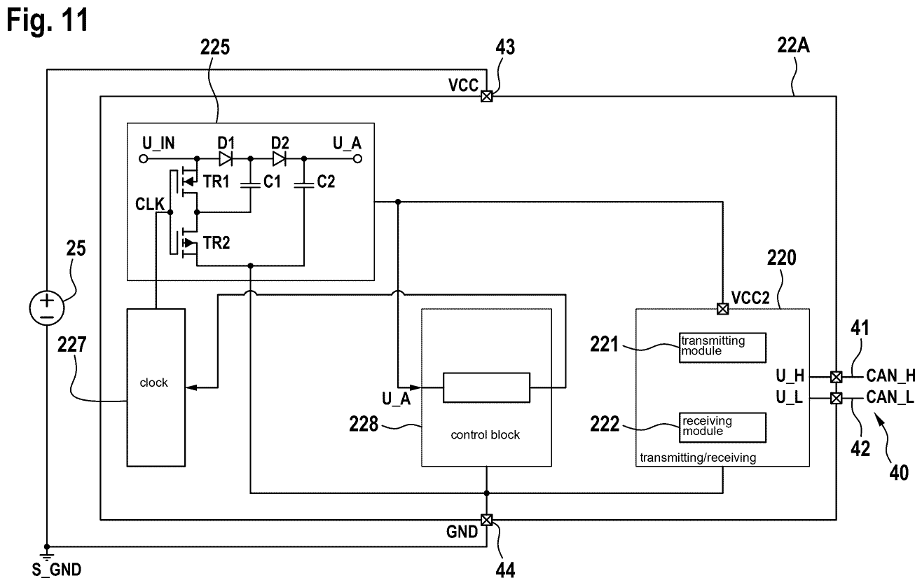

FIG. 11 shows a transmitting/receiving device 22A according to a second exemplary embodiment for the subscriber station 20 of FIG. 1.

In many parts, the transmitting/receiving device 22A is designed in the same way as the transmitting/receiving device 22 of the above-described exemplary embodiment. Therefore, only the differences from the transmitting/receiving device 22 of the above-described exemplary embodiment are described below.

In contrast to the transmitting/receiving device 22 of the above-described exemplary embodiment, the transmitting/receiving device 22A of FIG. 11 additionally has a control block 228. The input of the control block 228 is connected to the output of the transformation block 225. The output of the control block 228 is connected to the input of the clock block 227.

The control block 228 has a control loop 2281 for minimizing a ripple of the output voltage U_A of the transformation block 225. The control block 228, in particular the control loop 2281, controls the clock frequency CLK in the clock block 227 such that the transformation block 225 has the lowest possible ripple in the output voltage U_A.

The aim of the control is to reduce the ripple in such a way that the load dependence of the output voltage is reduced (see the equation (2) above). The control block 228, more precisely its control loop 2281, intervenes in the clock block 227 in such a way that, by adjusting the switching frequency f, the internal resistance R_i of the transformation block 225 is changed such that the output voltage U_A remains almost constant.

Alternatively, the control block 228, more precisely its control circuit 2281, can be designed as a voltage comparator with hysteresis, which stops the switching frequency f when a predetermined first voltage value is exceeded and starts the switching frequency f again when a predetermined second voltage level is undershot. Here, the predetermined second voltage level (upper voltage level) is greater than the predetermined first voltage level (lower voltage level). The resulting ripple of the output voltage U_A is thus given by the difference between the upper and lower voltage levels (hysteresis).

The control of the control block 228, in particular the control loop 2281, leads to an improvement of the EMC behavior.

Otherwise, the function of the transmitting/receiving device 22A is the same as described for the above-described exemplary embodiment.

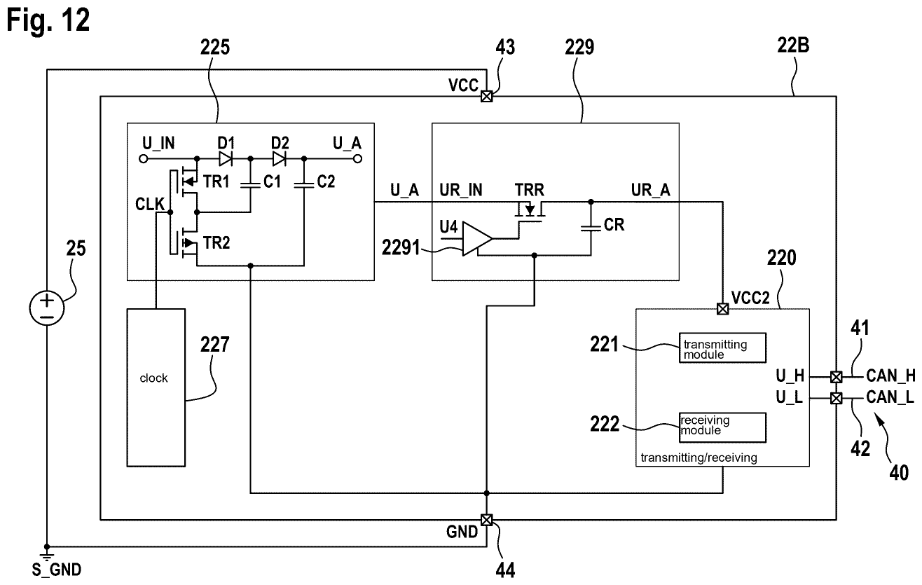

FIG. 12 shows a transmitting/receiving device 22B according to a third exemplary embodiment for the subscriber station 20 of FIG. 1.

The transmitting/receiving device 22B is largely designed in the same way as the transmitting/receiving device 22 of FIG. 10. Therefore, only the differences from the transmitting/receiving device 22 from FIG. 10 are described below.

In contrast to the transmitting/receiving device 22 of FIG. 10, the transmitting/receiving device 22B of FIG. 12 additionally has a control block 229. The input of the control block 229 is connected to the output of the transformation block 225. The output of the control block 229 is connected to the input VCC2 of the transmitting/receiving block 220.

The control block 229 has a transistor TRR, an operational amplifier 2291 and a capacitor CR. The transistor TRR is a CMOS transistor.

The source terminal of the transistor TRR is connected to the input of the control block 229. The gate terminal of the transistor TRR is connected to the output of the operational amplifier 2291. The drain terminal of the transistor TRR is connected to the output of the control block 229 and to a terminal of the capacitor CR or joined thereto. The capacitor CR is connected at its other terminal to the terminal 44 for ground (GND) or joined thereto. Thus, the capacitor CR is connected between the output of the control block 229 and the terminal 44 for ground (GND). In addition, the operational amplifier 2291 is connected to the terminal 44 for ground (GND) or joined thereto.

An input voltage UR IN of the control block 229 is equal to the output voltage U_A of the transformation block 225. A reference voltage U4 is applied to the input of the operational amplifier 2291. The control block 229 outputs an output voltage UR_A to the input VCC2 of the transmitting/receiving block 220.

The control block 229 is a linear regulator which regulates the output voltage U_A of the transformation block 225 to a predetermined output voltage UR_A.

This allows the output voltage U_A of the transformation block 225 to be regulated to a very precise setpoint value, in particular 5 V, for the input VCC2 of the transmitting/receiving block 220.

Otherwise, the function of the transmitting/receiving device 22B is the same as described in the first exemplary embodiment.

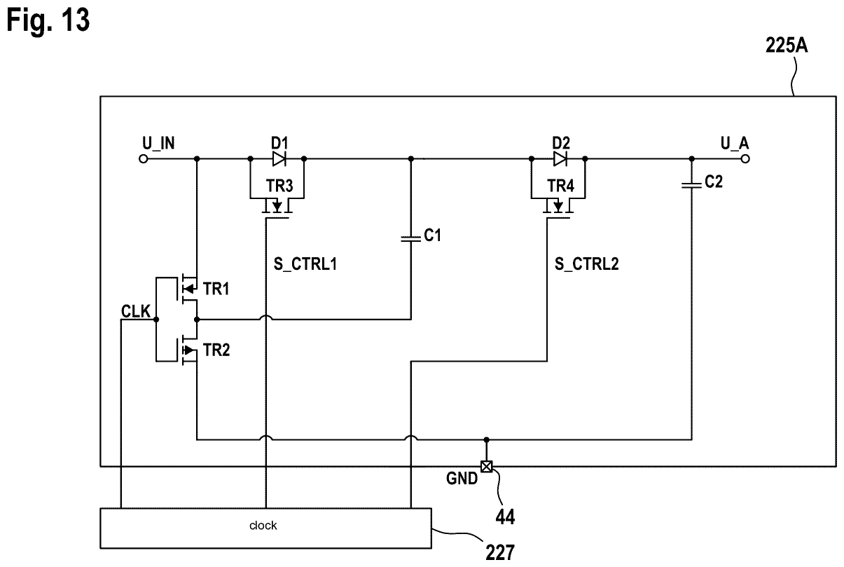

FIG. 13 shows a transformation block 225A according to a fourth exemplary embodiment, which can be used in at least one of the transmitting/receiving devices 22, 22A, 22B of the above-describe exemplary embodiments for the subscriber station 20 of FIG. 1.

The transformation block 225A is implemented in much the same way as transformation block 225 of FIG. 10. Therefore, only the differences from the transformation block 225 of FIG. 10 are described below.

The transformation block 225A additionally has a transistor TR3 and a transistor TR4. The source terminal of the transistor TR3 is connected to the anode of the diode D1. The drain terminal of the transistor TR3 is connected to the cathode of the diode D1. The source terminal of transistor TR4 is connected to the anode of diode D3. The drain terminal of the transistor TR3 is connected to the cathode of the diode D1. The gate terminal of the transistor TR3 is controlled by the clock generator 227 with a signal S_CTRL1. The gate terminal of the transistor TR4 is controlled by the clock generator 227 with a signal S_CTRL3. The transistors TR3, TR4 are each CMOS transistors. The control signals S_CTRL1 and S_CTRL2 of the transistors TR3 and TR4 are controlled from the clock block 227 such that the transistor TR3 supports the diode function of the diode D1 and the transistor TR4 supports the diode function of the diode D2.

In this case, “supports the diode function of the diode D1” means that the transistor TR3 is turned on when the diode D1 is forward biased to reduce the losses of the diode D1 and the transistor TR3 is turned off when the diode D1 is reverse biased. The same thing applies to the “supports the diode function of the diode D2” in reference to transistor TR4 and diode D2.

In the transformation block 225A, the diodes D1, D2 are each shunted out with a transistor, namely either the transistor TR3 or the transistor TR4. The shunting out results in a higher output voltage U_A of the transformation block 225A, because the losses caused by the forward voltage of the diodes D1, D2 are eliminated.

The circuit of FIG. 13 can be designed as follows, for example, using the aforementioned equations (2) and (3) for the charge pump.

According to the equation (2) given above, the output voltage of the unloaded charge pump is: U_A0=3.3 V*2=6.6 V, wherein the following applies to the voltage of FIG. 13 across the diode D1 with transistor TR3 turned on and diode D2 with transistor TR4 turned on: Vdio=0 V. If an electrical current through the load on the charge pump of I_L=80 mA is assumed and the target is U_A min=5.0 V, the design target for the internal resistance R_i is:

$$R\_i = ( 6.6 V - 5. V ) / 80 mA = 20 ohms$$

The switching transistors should have an on-resistance Ron of <2 ohms in order not to significantly degrade the internal resistance R_i of the charge pump. The following applies: On-resistance Ron_switch˜ 1/10 of R_i.

According to formula (3) (R_i=1/(f*C1)), the following values result for the pump capacitor C1 depending on the switching frequency f of the charge pump:

$$f = 150 kHz \to C 1 = 470 nF$$

$$f = 10 MHz \to C 1 = 5 nF$$

$$f = 50 MHz \to C 1 = 1 nF$$

The total required gate charge for all switches of the charge pump is approximately 400 pC. This results in the following average current consumptions I_cp_avg for the pump capacitor C1 for the different switching frequencies f:

$$f = 150 kHz \to I\_cp \_avg = 50 μA$$

$$f = 10 MHz \to I\_cp \_avg = 4 mA$$

$$f = 50 MHz \to I\_cp \_avg = 20 mA$$

The capacitors C1, C2 and CR can be integrated monolithically only with a huge Si area requirement. This is generally not done for cost reasons. The capacitors may, for example, be installed in the same housing together with a transceiver die according to the following technologies, which die refers to a transmitting/receiving device 22 without a (plastics or ceramic) housing. The technologies are flip-chip or stacked-die or chip-to-chip or silicon caps.

Of course, other values for the design of the charge pump are possible.

All above-described embodiments of the transmitting/receiving devices 12, 22, the subscriber stations 10, 20, 30, the bus system 1 and the method carried out therein according to the exemplary embodiment and their modifications can be used individually or in all possible combinations. Additionally, the following modifications are possible in particular.

The above-described bus system 1 is described on the basis of a bus system based on the CAN protocol. However, the bus system 1 according to the exemplary embodiment may alternatively be another type of communication network in which the signals are transmitted as differential signals.

It is advantageous, but not necessarily a prerequisite, for exclusive, collision-free access of a subscriber station 10, 20, 30 to the bus 40 to be ensured in the bus system 1, at least for certain time periods.

The bus system 1 according to the exemplary embodiment and its modifications is in particular a bus system in which communication can take place between at least two of the subscriber stations 10, 20, 30 according to two different CAN standards, such as CAN-HS or CAN FD or CAN SIC or CAN XL. The functionality of the above-described exemplary embodiment can thus be used, for example, in transmitting/receiving devices 12, 22 that are to be operated in such a bus system.

It is possible that the transmitting/receiving device 22A of FIG. 11 has not only a control block 228, but also a control block 229 as described for the transmitting/receiving device 22A of FIG. 12.

The number and arrangement of the subscriber stations 10, 20, 30 in the bus system 1 according to the exemplary embodiment and their modifications can be selected as desired. In particular, only subscriber stations 20 are available.

In particular, it is possible that the subscriber station 10 has a bus voltage supply of 3.3 V and the subscriber station 20 has a bus voltage supply of 5.0 V. The number and arrangement of the subscriber stations 10, 20, 30 in such a bus system 1 can be freely selected. In particular, only subscriber stations 10 are available.

In addition, the bus voltage supply of one of the subscriber stations 10, 20, 30 is not limited to 3.3 V. The bus voltage supply can have a value other than 3.3 V. The above-described principle of the bus system 1 with subscriber stations 10, 20, 30 in mixed operation can also be applied here. If necessary, the voltages of the devices 22, 22A, 22B and/or the block 220 have to be adjusted accordingly.

What is claimed is:

1. A transmitting/receiving device for a subscriber station of a serial bus system, comprising:
a transmitting/receiving block configured to transmit a digital transmit signal as an analog differential signal to a bus of the bus system in order to transmit a message to at least one other subscriber station of the bus system, and/or for receiving an analog signal from the bus;
a transformation block configured to output a voltage as a voltage supply for the transmitting/receiving block; and
a terminal for an external voltage source, wherein the transformation block is connected between the terminal for the external voltage source and the transmitting/receiving block;
wherein the transformation block is configured to transform a supply voltage applied to the terminal into a voltage which has a higher voltage value than the supply voltage applied to the terminal.

2. The transmitting/receiving device according to claim 1, wherein the supply voltage applied to the terminal is a direct voltage.

3. The transmitting/receiving device according to claim 1, wherein:
the supply voltage applied to the terminal is a voltage having a voltage value of approximately 3.3 V and at least 3.0 V; and
the voltage output by the transformation block is a voltage having a voltage value of approximately 5.0 V.

4. The transmitting/receiving device according to claim 1, wherein the transformation block includes:
a first transistor and a second transistor, wherein drain drain terminals of the first transistor and the second transitory are connected to one another; and
a first diode and a second diode connected in series between an input of the transformation block and an output of the transformation block;
wherein the source terminal of the first transistor is connected to an anode of the first diode,
wherein a terminal of a first capacitor is connected to a cathode of the first diode, and another terminal of the first capacitor is connected to the drain terminals of the first transitory and the second transistors, and
wherein a terminal of a second capacitor is connected to a cathode of the second diode, and another terminal of the capacitor is connected to a source terminal of the second transistor and a terminal for ground.

5. The transmitting/receiving device according to claim 1, further comprising:
a clock block configured to control the transformation block with a clock signal for transforming the supply voltage applied to the terminal for the external voltage source into the voltage which has a higher voltage value than the supply voltage applied to the terminal for the external source.

6. The transmitting/receiving device according to claim 4, wherein gate terminals of the first transistor and the second transistor are connected to one another.

7. The transmitting/receiving device according to claim 5, wherein the clock block is connected to gate terminals of the first transistor and the second transistor to drive the first transistor and the second transistor with the clock signal.

8. The transmitting/receiving device according to claim 4, wherein the transformation block further includes:
a third transitory and a fourth transistor,
wherein the third transistor shunts the first diode, and
wherein the fourth transistor shunts the second diode.

9. The transmitting/receiving device according to claim 5, wherein the transmitting/receiving block, the transformation block, the clock block, and the terminal for the external voltage source are arranged monolithically on a semiconductor chip.

10. The transmitting/receiving device according to claim 1, further comprising:
a first control block configured to control a ripple of the voltage output by the transformation block to a minimum value.

11. The transmitting/receiving device according to claim 1, further comprising:
a second control block configured to control the voltage output by the transformation block to a predetermined voltage value.

12. The transmitting/receiving device according to claim 11, wherein:
wherein the second control block includes a transistor, a capacitor, and an operational amplifier, and
wherein the transistor of the second control block is connected between the output of the transformation block and the transmitting/receiving block,
wherein an output of the operational amplifier is connected to a gate terminal of the transistor of the second control block, and
wherein the capacitor of the second control block is connected at one terminal to a drain terminal of the transistor of the second control block and at another terminal, to a terminal for ground.

13. The transmitting/receiving device according to claim 1, wherein the transmitting/receiving device is configured to generate the analog differential signal in a first communication phase of the message with a different physical layer than in a second communication phase.

14. A subscriber station for a serial bus system, comprising:
a transmitting/receiving device, including:
a transmitting/receiving block configured to transmit a digital transmit signal as an analog differential signal to a bus of the bus system in order to transmit a message to at least one other subscriber station of the bus system, and/or for receiving an analog signal from the bus,
a transformation block configured to output a voltage as a voltage supply for the transmitting/receiving block, and
a terminal for an external voltage source, wherein the transformation block is connected between the terminal for the external voltage source and the transmitting/receiving block,
wherein the transformation block is configured to transform a supply voltage applied to the terminal into a voltage which has a higher voltage value than the supply voltage applied to the terminal; and
a communication control device configured to control communication in the serial bus system and to a transmit signal;
wherein the subscriber station is configured or communication in a bus system in which exclusive, collision-free access of a subscriber station to the bus of the bus system is ensured at least temporarily.

15. A bus system, comprising:
a bus; and
at least two subscriber stations which are connected to one another via the bus in such a way that they can communicate serially with one another and of which at least one of the subscriber stations includes:
a transmitting/receiving device, including:
a transmitting/receiving block configured to transmit a digital transmit signal as an analog differential signal to a bus of the bus system in order to transmit a message to at least one other subscriber station of the bus system, and/or for receiving an analog signal from the bus,
a transformation block configured to output a voltage as a voltage supply for the transmitting/receiving block, and
a terminal for an external voltage source, wherein the transformation block is connected between the terminal for the external voltage source and the transmitting/receiving block,
wherein the transformation block is configured to transform a supply voltage applied to the terminal into a voltage which has a higher voltage value than the supply voltage applied to the terminal; and
a communication control device configured to control communication in the serial bus system and to a transmit signal;
wherein the subscriber station is configured or communication in a bus system in which exclusive, collision-free access of a subscriber station to the bus of the bus system is ensured at least temporarily.

16. A method for communication using differential signals in a serial bus system, wherein the method is carried out using a transmitting/receiving device for a subscriber station of the serial bus system, the transmitting/receiving device having a transmitting/receiving block, a transformation block, and a terminal for an external voltage source, wherein the transformation block is connected between the terminal for the external voltage source and the transmitting/receiving block, and wherein the method comprises the following steps:
outputting, using the transformation block, a voltage as a voltage supply for the transmitting/receiving block; and
(i) transmitting a digital transmit signal as an analog differential signal to a bus of the bus system using voltage output by the transformation block in order to transmit a message to at least one other subscriber station of the bus system, and/or (ii) receiving an analog signal from the bus using the voltage output by the transformation block;
wherein the transformation block configured to transform a supply voltage applied to the terminal for the external voltage source into a voltage which has a higher voltage value than the supply voltage applied to the terminal for the external voltage source.
